(19) United States
(12) Patent Application Publication
(10) Pub. No.: US 2018/0212655 A1
(43) Pub. Date: Jul. 26, 2018

(54) METHODS AND SYSTEMS FOR DISTRIBUTED UPLINK MIMO COMMUNICATIONS

(71) Applicant: QUALCOMM Incorporated, San Diego, CA (US)

(72) Inventors: Venkata Ramanan Venkatachalam Jayaraman, San Diego, CA (US); Abhishek Pramod Patil, San Diego, CA (US); George Cherian, San Diego, CA (US); Yan Zhou, San Diego, CA (US); Alfred Asterjadhi, San Diego, CA (US); Simone Merlin, San Diego, CA (US)

(21) Appl. No.: 15/863,303

(22) Filed: Jan. 5, 2018

Related U.S. Application Data
(60) Provisional application No. 62/449,517, filed on Jan. 23, 2017.

(51) Int. Cl. H04B 7/0452; H04W 72/04; H04B 7/06; H04W 74/08

(52) U.S. Cl. CPC H04B 7/0452; H04W 72/04; H04W 84/12; H04W 74/0858; H04B 7/0626

(57) ABSTRACT

Methods and systems for receiving an uplink transmission are disclosed. In one aspect, a method includes receiving, by an electronic device, a multiuser transmission from a first station and a second station of a wireless network. The first station is in a basic service set (BSS) and the second station is outside the BSS, and processing the multiuser transmission to obtain uplink data from the first station.

### CROSS REFERENCE TO RELATED APPLICATION(S)

This application claims the benefit of U.S. Provisional Application No. 62/449,517 titled “METHODS AND SYSTEMS FOR DISTRIBUTED UPLINK MIMO COMMUNICATIONS,” filed Jan. 23, 2017. The content of this prior application is considered part of this application and is hereby incorporated by reference in its entirety.

### TECHNICAL FIELD

This application relates generally to wireless communication, and more specifically to systems and methods for performing distributed MIMO wireless communication.

### BACKGROUND

Wireless communications systems are widely deployed to provide various types of communication content such as voice, video, packet data, messaging, broadcast, and so on. Wi-Fi or WiFi (e.g., IEEE 802.11) is a technology that allows electronic devices to connect to a wireless local area network (WLAN). A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs). The AP may be coupled to a network, such as the Internet, and may enable one or more STAs to communicate via the network or with other STAs coupled to the AP.

Many wireless networks utilize carrier-sense multiple access with collision detection (CSMA/CD) to share a wireless medium. With CSMA/CD, before transmission of data on the wireless medium, a device may listen to the medium to determine whether another transmission is in progress. If the medium is idle, the device may attempt a transmission. The device may also listen to the medium during its transmission, so as to detect whether the data was successfully transmitted, or if perhaps a collision with a transmission of another device occurred. When a collision is detected, the device may wait for a period of time and then re-attempt the transmission. The use of CSMA/CD allows for a single device to utilize a particular channel (such as a spatial or frequency division multiplexing channel) of a wireless network.

Users continue to demand greater and greater capacity from their wireless networks. For example, video streaming over wireless networks is becoming more common. Video teleconferencing may also place additional capacity demands on wireless networks. In order to satisfy the bandwidth and capacity requirements users require, improvements in the ability of a wireless medium to carry larger and larger amounts of data are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In certain embodiments, a method of receiving an uplink transmission comprises receiving, by an electronic device, a multiuser transmission from a first station and a second station of a wireless network. The first station is in a basic service set (BSS) and the second station is outside the BSS. The method further comprises processing the multiuser transmission to obtain uplink data from the first station.

In certain embodiments, a method coordinates a distributed uplink transmission. The method comprises determining, by an electronic device, that a first station associated with a first access point and a second station associated with a second access point will participate in a distributed uplink multiuser communication. The method further comprises transmitting, by the electronic device, a message to the first access point indicating the first station will participate in the distributed uplink multiuser communication.

In certain embodiments, a method performs a portion of a distributed uplink MIMO communication. The method comprises receiving, by a station, associated with a first access point having a basic service set (BSS), transmission parameters for a distributed uplink MIMO communication. The method further comprises transmitting, by the station, a portion of the distributed uplink MIMO communication to a second access point that is outside the BSS based on the received transmission parameters.

In certain embodiments, an apparatus for wireless communication comprises an electronic hardware processor configured receive an uplink transmission. The electronic hardware processor is configured to receive a multiuser transmission from a first station and a second station of a wireless network. The first station is in a basic service set (BSS) and the second station is outside the BSS. The electronic hardware processor is further configured to process the multiuser transmission to obtain uplink data from the first station.

In certain embodiments, an apparatus for wireless communication comprises an electronic hardware processor configured to coordinate a distributed uplink transmission. The electronic hardware processor is configured to: determine, by an electronic device, that a first station associated with a first access point and a second station associated with a second access point will participate in a distributed uplink multiuser communication. The electronic hardware process or is further configured to transmit, by the electronic device, a message to the first access point indicating the first station will participate in the distributed uplink multiuser communication.

In certain embodiments, an apparatus for wireless communication comprises an electronic hardware processor configured to perform a portion of a distributed uplink MIMO communication. The electronic hardware processor is configured to: receive, by a station, associated with a first access point having a basic service set (BSS), transmission parameters for a distributed uplink MIMO communication. The electronic hardware processor is further configured to transmit, by the station, a portion of the distributed uplink MIMO communication to a second access point that is outside the BSS based on the received transmission parameters.

In certain embodiments, a non-transitory computer-readable medium comprises instructions that, when executed, perform a method of receiving an uplink transmission. The method comprises receiving, by an electronic device, a multiuser transmission from a first station and a second station of a wireless network. The first station is in a basic service set (BSS) and the second station is outside the BSS. The method further comprises processing the multiuser transmission to obtain uplink data from the first station.

In certain embodiments, a non-transitory computer-readable medium comprises instructions that, when executed, perform a method of coordinating a distributed uplink transmission. The method comprises determining, by an electronic device, that a first station associated with a first access point and a second station associated with a second access point will participate in a distributed uplink multiuser communication. The method further comprises transmitting, by the electronic device, a message to the first access point indicating the first station will participate in the distributed uplink multiuser communication.

In certain embodiments, a non-transitory computer-readable medium comprises instructions that, when executed, perform a method of performing a portion of a distributed uplink MIMO communication. The method comprises receiving, by a station, associated with a first access point having a basic service set (BSS), transmission parameters for a distributed uplink MIMO communication. The method further comprises transmitting, by the station, a portion of the distributed uplink MIMO communication to a second access point that is outside the BSS based on the received transmission parameters.

### BRIEF DESCRIPTION OF THE DRAWINGS

FIG. 1 schematically illustrates an example wireless communication system in which aspects of the present disclosure may be employed.

FIG. 2 schematically illustrates an example wireless device that may be employed within the example wireless communication system of FIG. 1.

FIG. 3 schematically illustrates an example configuration of a distributed MIMO wireless communication system in accordance with certain embodiments described herein.

FIG. 4 schematically illustrates example communication options compatible with a distributed MIMO wireless communication system in accordance with certain embodiments described herein.

FIG. 5 schematically illustrates an example plurality of basic service sets (BSSs) of a distributed MIMO wireless communication system grouped into clusters in accordance with certain embodiments described herein.

FIG. 6 schematically illustrates an example distributed MIMO communication system in accordance with certain embodiments described herein.

FIG. 7 schematically illustrates another example distributed MIMO communication system in accordance with certain embodiments described herein.

FIG. 8 is a flow diagram of an example method for receiving an uplink transmission in accordance with certain embodiments described herein.

FIG. 9 is a flow diagram of an example method for coordinating a distributed uplink transmission in accordance with certain embodiments described herein.

FIG. 10 is a flow diagram of an example method for performing a portion of a distributed uplink MIMO communication in accordance with certain embodiments described herein.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary′ is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (“APs”) and clients (also referred to as stations, or “STAs”). In general, an AP serves as a hub or a base station for the STAs in the WLAN. A STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations an STA may also be used as an AP.

An access point (“AP”) may comprise, be implemented as, or known as a NodeB, Radio Access network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

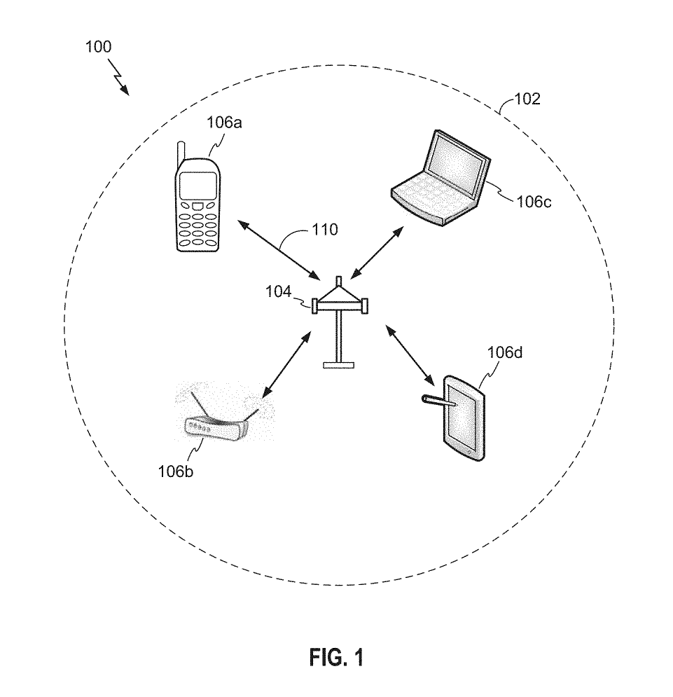

FIG. 1 is a diagram that illustrates a multiple-access multiple-input multiple-output (MIMO) system 100 with APs and STAs. For simplicity, only one AP 104 is shown in FIG. 1. As described above, the AP 104 communicates with the STAs 106a-d (also referred to herein collectively as “the STAs 106” or individually as “the STA 106”) and may also be referred to as a base station or using some other terminology. Also as described above, a STA 106 may be fixed or mobile and may also be referred to as a user terminal, a mobile station, a wireless device, or using some other terminology. The AP 104 may communicate with one or more STAs 106 at any given moment on the downlink or uplink. The downlink (i.e., forward link) is the communication link from the AP 104 to the STAs 106, and the uplink (i.e., reverse link) is the communication link from the STAs 106 to the AP 104. A STA 106 may also communicate peer-to-peer with another STA 106. As described herein, the term “communicate” may indicate aspects related to device association. As one non-limiting example, “a first device communicating with a first access point” may indicate that the first device is associated with the first access point. It should be understood that “a first device communicating with a first access point” may not necessarily indicate that the first device is associated with the first access point (e.g., the first device may be unassociated with the first access point). As another non-limiting example, “a first device communicating with a first access point” may indicate that the first device has determined to associate with the first access point.

Portions of the following disclosure will describe STAs 106 capable of communicating via Spatial Division Multiple Access (SDMA). Thus, for such aspects, the AP 104 may be configured to communicate with both SDMA and non-SDMA STAs. This approach may conveniently allow older versions of STAs (e.g., “legacy” STAs) that do not support SDMA to remain deployed in an enterprise, extending their useful lifetime, while allowing newer SDMA STAs to be introduced as deemed appropriate.

The MIMO system 100 may employ multiple transmit and multiple receive antennas for data transmission on the downlink and uplink. The AP 104 is equipped with Nap antennas and represents the multiple-input (MI) for downlink transmissions and the multiple-output (MO) for uplink transmissions. A set of K selected STAs 106 collectively represents the multiple-output for downlink transmissions and the multiple-input for uplink transmissions. For pure SDMA, it is desired to have Nap≤K≤1 if the data symbol streams for the K STAs are not multiplexed in code, frequency or time by some means. K may be greater than Nap if the data symbol streams can be multiplexed using TDMA technique, different code channels with CDMA, disjoint sets of sub-bands with OFDM, and so on. Each selected STA may transmit user-specific data to and/or receive user-specific data from the AP. In general, each selected STA may be equipped with one or multiple antennas (i.e., Nut 1). The K selected STAs can have the same number of antennas, or one or more STAs may have a different number of antennas.

The MIMO system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each STA may be equipped with a single antenna (e.g., in order to keep costs down) or multiple antennas (e.g., where the additional cost can be supported). The MIMO system 100 may also be a TDMA system if the STAs 106 share the same frequency channel by dividing transmission/reception into different time slots, where each time slot may be assigned to a different STA 106.

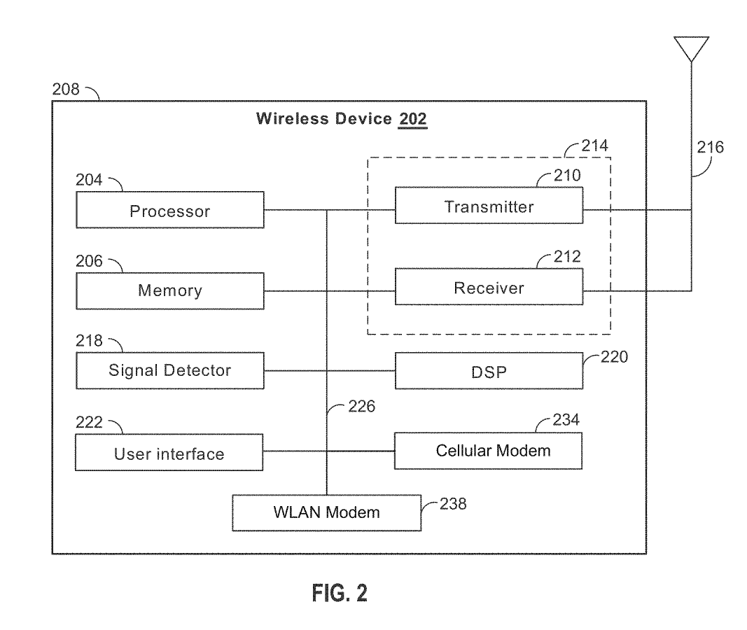

FIG. 2 illustrates various components that may be utilized in a wireless device 202 that may be employed within the wireless communication MIMO system 100. The wireless device 202 is an example of a device that may be configured to implement the various methods described herein. The wireless device 202 may implement an AP 104 or a STA 106.

The wireless device 202 may include an electronic hardware processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more electronic hardware processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. A single or a plurality of transceiver antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface 222, cellular modem 234, and a wireless LAN (WLAN) modem 238. The cellular modem 234 may provide for communication using cellular technologies, such as CDMA, GPRS, GSM, UTMS, or other cellular networking technology. The WLAN modem 238 may provide for communications using one or more WiFi technologies, such as any of the IEEE 802.11 protocol standards.

The various components of the wireless device 202 may be coupled together by a bus system, which may include a power bus, a control signal bus, and a status signal bus in addition to a data bus.

Certain aspects of the present disclosure support transmitting an uplink (UL) signal or a downlink (DL) signal between one or more STAs and an AP. In some embodiments, the signals may be transmitted in a multi-user MIMO (MU-MIMO) system. Alternatively, the signals may be transmitted in a multi-user FDMA (MU-FDMA) or similar FDMA system. In some aspects, these signals may be transmitted over one or more of the transmitter 210 and the WLAN modem 238.

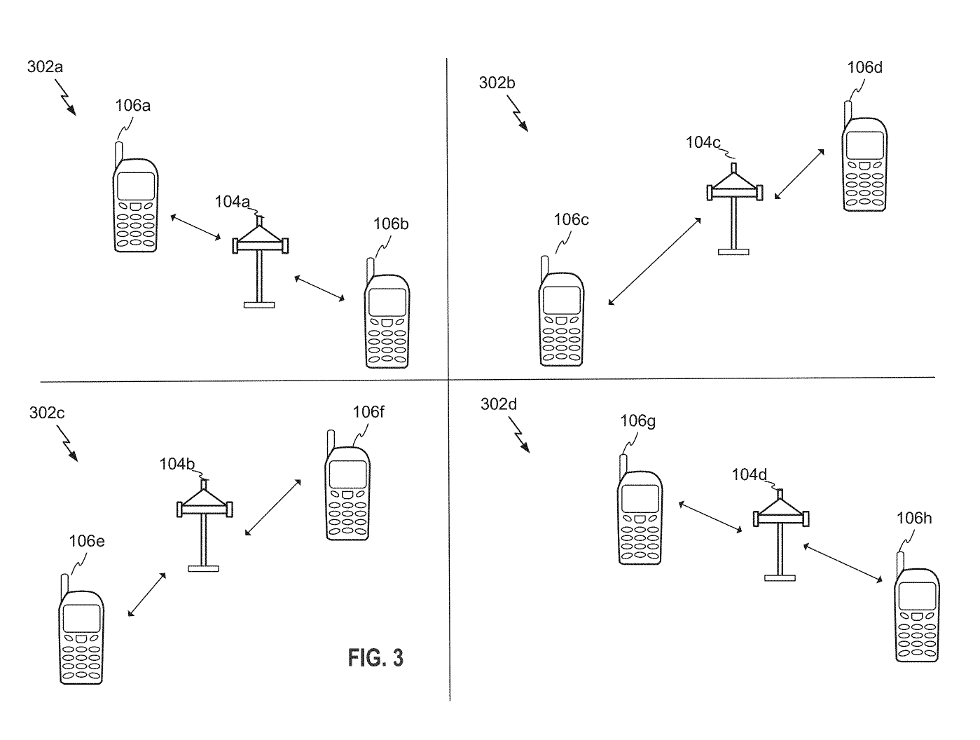

FIG. 3 shows four basic service sets (BSSs) 302a-d, each BSS including an access point 104a-d respectively. Each access point 104a-d is associated with at least two stations within its respective BSS 302a-d. AP 104a is associated with STA 106a-b. AP 104b is associated with STA 106c-d. AP 104c is associated with STA 106e-f. AP 104d is associated with STAs 106g-h. An AP that is associated with a STA may be referred to as a BSS AP for the STA throughout this disclosure. Similarly, an AP for which there is no association with a particular STA may be referred to as an OBSS AP for the STA throughout this disclosure. Associations between an AP and one or more stations provides for, in part, coordination of communication between devices within the basic service set (BSS) defined by the AP and its associated STAs. For example, devices within each BSS may exchange signals with each other. The signals may function to coordinate transmissions from the respective AP 104a-d and stations within the AP's BSS 302a-d.

The devices shown in FIG. 3, including the AP's 104a-d and STA 106a-h, also share a wireless medium. Sharing of the wireless medium is facilitated, in some aspects, via the use of carrier sense media access with collision detection (CSMA/CD). The disclosed embodiments may provide for a modified version of CSMA/CD that provides for an increase in an ability for the BSSs 302a-d to communicate simultaneously when compared to known systems.

The stations 106a-h within the BSSs 302a-d may have different abilities to receive transmissions from their associated AP based, at least in part, on their position relative to the other APs and/or stations outside their respective BSS (OBSS). For example, because the stations 106a, 106d, 106e, and 106h are positioned relatively far from OBSS APs, these stations may have an ability to receive transmissions from their BSS AP even with an OBSS AP or STA is transmitting. Stations having such receive characteristics may be referred to as Reuse STAs throughout this disclosure.

In contrast, STAs 106b, 106c, 106f, and 106g are illustrated in positions that are relatively close to an OBSS AP. Thus, these stations may have less ability to receive transmissions from their BSS AP during transmissions from OBSS AP's and/or OBSS STAs. Stations having such receive characteristics may be referred to as non-reuse or edge STAs throughout this disclosure. In some aspects, the disclosed methods and systems may provide for an improved ability for the non-reuse STAs to communicate concurrently while other OBSS devices are also communicating on the wireless medium.

In at least some of the disclosed aspects, two or more of the APs 104a-d may negotiate to form a cluster of access points. In other aspects, cluster configurations may be defined via manual configuration. For example, each AP may maintain configuration parameters indicating whether the AP is part of one or more cluster, and if so, a cluster identifier for the cluster. In some aspects, the configuration may also indicate whether the AP is a cluster controller for the cluster. In some of the embodiment disclosed herein, a cluster controller may take on functions that differ from APs that are part of the cluster but are not a cluster controller. Thus, in some aspects, two or more of APs 104a-d may be included in the same cluster. STAs associated with those access points may also be considered to be included in or part of the cluster of their associated AP. Therefore, in some aspects the STAs a-h illustrated above may be part of the same cluster.

The cluster of access points may coordinate transmissions between themselves and their associated APs. In some aspects, the cluster may be identified via a cluster identifier that uniquely identifies the group of access points comprising the cluster. In some aspects, during association of a station with any of the APs in a cluster, the cluster identifier is transmitted to the station during association, for example, in an association response message. The station may then utilize the cluster identifier to coordinate communications within the cluster. For example, one or more messages transmitted over the wireless network may include the cluster identifier, which a receiving STA may use to determine whether the message is addressed to it or not.

Embodiments that cluster of access points may also utilize various methods to identify STAs within the cluster. For example, as known methods of generating association identifiers (AIDs) may not provide uniqueness across access points, in some aspects, media access control (MAC) addresses may be utilized to identify stations where appropriate. For example, known messages including user info fields that utilize association identifiers to identify stations may be modified to contain data derived from station MAC addresses in the disclosed embodiments. Alternatively, methods of generating association identifiers may be modified to ensure uniqueness within a cluster of access points. For example, a portion of the association identifier may uniquely identify an access point within the cluster. Stations associated with that access point would be assigned association identifiers including the unique identification. This provides unique association identifiers across access points within a cluster. In some other aspects, an association identifier within a cluster may include the cluster identifier. This may provide for uniqueness across clusters to facilitate future cross-cluster coordination of communication.

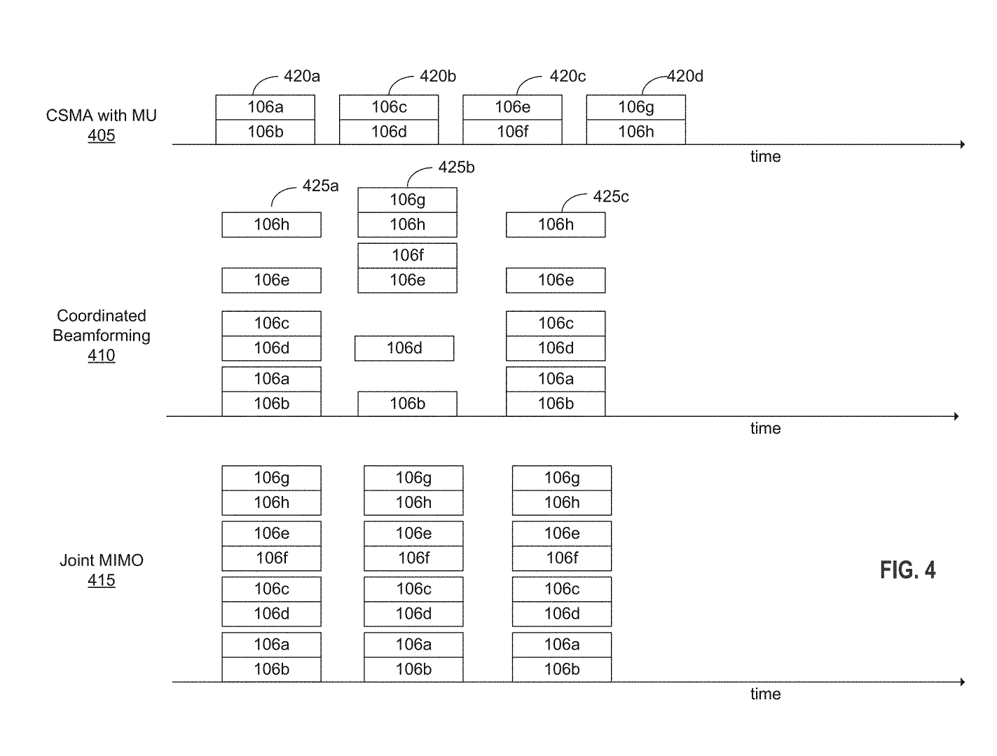

FIG. 4 shows three exemplary approaches to arbitrating the wireless medium with the communications system 300 of FIG. 3. Approach 405 utilizes carrier sense media access (CSMA) to perform single BSS multi-user transmissions. For example, each of transmissions 420a-d may be performed by the BSSs 302a-d of FIG. 3 respectively. The use of traditional CSMA in approach 405 causes the medium to be utilized by only one BSS at any point in time.

Approach 410 utilizes coordinated beamforming. With the coordinated beamforming approach 410, the APs 104a-d may coordinate transmissions between their respective BSSs. In some aspects, this coordination may be performed over the wireless medium, or in some aspects, over a back-haul network. In these aspects, the coordination traffic over the backhaul network provided for improved utilization of the wireless medium.

With this approach, reuse STAs for different BSSs may be scheduled to transmit or receive data concurrently. For example, a relative strength of a communication channel between STA 106a and AP 104a may allow these two devices to exchange data simultaneously with communication with OBSS devices, such as, for example, AP 104b and STA 106d. In addition, approach 410 provides for non-reuse STAs may be scheduled to transmit concurrently with OBSS devices. For example, STA 106b, which is within BSS 302, may be scheduled to communicate simultaneous with communication between AP 104d and STA 106h of BSS 302d. Such simultaneous communication between a non-reuse STA (such as STA 106b) and, for example, AP 104d may be facilitated by scheduling AP 104d to transmit a signal to STA 106b simultaneous with AP 104d's transmission to STA 106h. For example, AP 104d may transmit a null signal for dominant interfering signals to STA 106b. Thus, while transmitting a first signal to STA 106h, AP 104d may simultaneously transmit a signal nulling the first signal to STA 106b. Such simultaneous transmission by the AP 104d may be provided by selecting individual antenna(s) of a plurality of antennas provided by AP 104d for each of the transmissions.

Approach 415 shows an exemplary joint multi-user communication or a distributed MIMO communication across access points 104a-d within the BSSs 302a-d. With this joint MIMO approach 415, a cluster of APs (such as APs 104a-d) may service N 1-SS STAs simultaneously, where N is ˜¾ of a total number of antennas across all APs within the cluster. Distributed MIMO communications may coordinate a collection of antennas across the multiple APs within a cluster to transmit to stations within the cluster. Thus, while traditional MIMO methods allocate transmit antennas within a single BSS to stations within the BSS, distributed MIMO provides for allocation of transmit antennas outside a BSS to facilitate communications with stations within the BSS.

In a distributed MIMO communication, a station in one BSS may communicate with one or more access points in another, different BSS. Thus, for example, station 106a of BSS 302a of FIG. 3 may communication with access point 104d, which is in BSS 302d. This communication may occur simultaneously with communication between STA 106a and AP 104a, the BSS AP of the STA 106a. In some aspects of an uplink distributed MIMO communication, the STA 106a may conduct one or more uplink communications to AP 104a simultaneously with AP 104d. Alternatively, a downlink distributed MIMO communication may include AP 104a transmitting data to STA 106a simultaneously with a transmission from AP 104d to STA 106a.

Thus, one or more of the distributed embodiments may utilize MIMO in the form of Cooperative Multipoint (CoMP, also referred to as e.g. Network MIMO (N-MIMO), Distributed MIMO (D-MIMO), or Cooperative MIMO (Co-MIMO), etc.) transmission, in which multiple access points maintaining multiple corresponding basic service sets, can conduct respective cooperative or joint communications with one or more STAs 106. CoMP communication between STAs and APs can utilize for example, a joint processing scheme, in which an access point associated with a station (a BSS AP) and an access point that is not associated with a station (a OBSS AP) cooperate to engage in transmitting downlink data to the STA and/or jointly receiving uplink data from the STA. Additionally or alternatively, CoMP communication between an STA and multiple access points can utilize coordinated beamforming, in which a BSS AP and an OBSS AP can cooperate such that an OBSS AP forms a spatial beam for transmission away from the BSS AP and, in some aspects, at least a portion of its associated stations, thereby enabling the BSS AP to communicate with one or more of its associated stations with reduced interference.

To facilitate the coordinated beamforming approach 410 or the joint MIMO approach 415, an understanding of channel conditional between an access point and OBSS devices may provide for greater wireless communication efficiency.

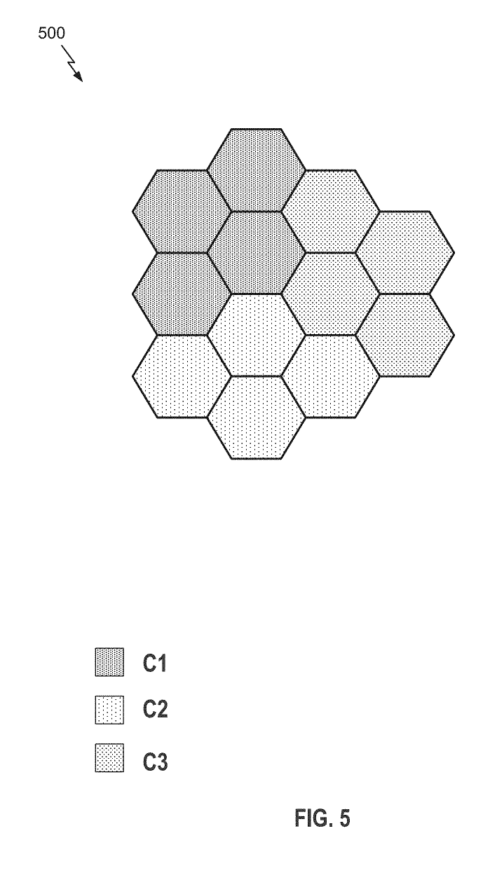

FIG. 5 schematically illustrates a plurality of basic service sets (BSSs) 500 of an exemplary distributed MIMO wireless communication system. Each hexagon of FIG. 5 represents an access point and associated stations, collectively referred to as a basic service set (BSS). The individual BSSs are grouped into clusters in accordance with certain embodiments described herein. In the example schematically illustrated by FIG. 5, a first cluster (C1) comprises four BSSs, a second cluster (C2) comprises four BSSs, and a third cluster (C3) comprises four BSSs. In certain other embodiments, a cluster can comprise 2, 3, 4, 5, or any numbers of BSSs and a wireless communication system can comprise one or more clusters (e.g., 2, 3, 4, 5 or other numbers of clusters).

In certain embodiments, to perform distributed MIMO communications, devices within two or more BSS's of a cluster may transmit over a single channel simultaneously (e.g., transmit data from a plurality of access points of the BSS simultaneously via the single channel, or transmit data from a plurality of stations in different BSS's simultaneously to a single AP). In some aspects, a centralized scheduler (not shown) may coordinate transmissions across the clusters C1-C3. For example, coordination may include selecting which devices will transmit simultaneously from multiple BSSs to perform a joint MIMO communication.

The systems and methods described herein for enabling neighboring APs to coordinate simultaneous transmissions to multiple stations within and outside their basic service sets provide certain technical benefits. As one non-limiting example, the systems and methods described herein may improve overall system throughput, for example, by servicing an increased number of stations without requiring additional time (e.g., by more efficiently using the wireless spectrum, as described below). As another non-limiting example, when a station transmits duplicate and/or encoded data to the APs in the network, the systems and methods for transmission described herein may improve spatial diversity and data reliability, for example, as compared with transmitting one or more “null signals” to unassociated APs in the network.

In uplink multiuser MIMO communication compatible with IEEE 802.11ax, a single access point processes (e.g., decodes) data streams from a set of stations associated with the access point. In uplink distributed MIMO communication, multiple access points process (e.g., decode) data streams from a set of stations, with each station associated with one of the access points and not associated with the other access points. Not all the stations are associated with the same access point. In uplink distribute MIMO communication, it is not necessary that a receiving access point process (e.g., decode) the data streams from all of the stations. For example, an access point associated with a first station and a second station, and not associated with a third station and a fourth station, processes (e.g., decodes) data transmissions from the first and second stations and does not process (e.g., discards; ignores; does not decode) data transmissions from the third and fourth stations (e.g., after or during processing of the data transmissions from the first and second stations).

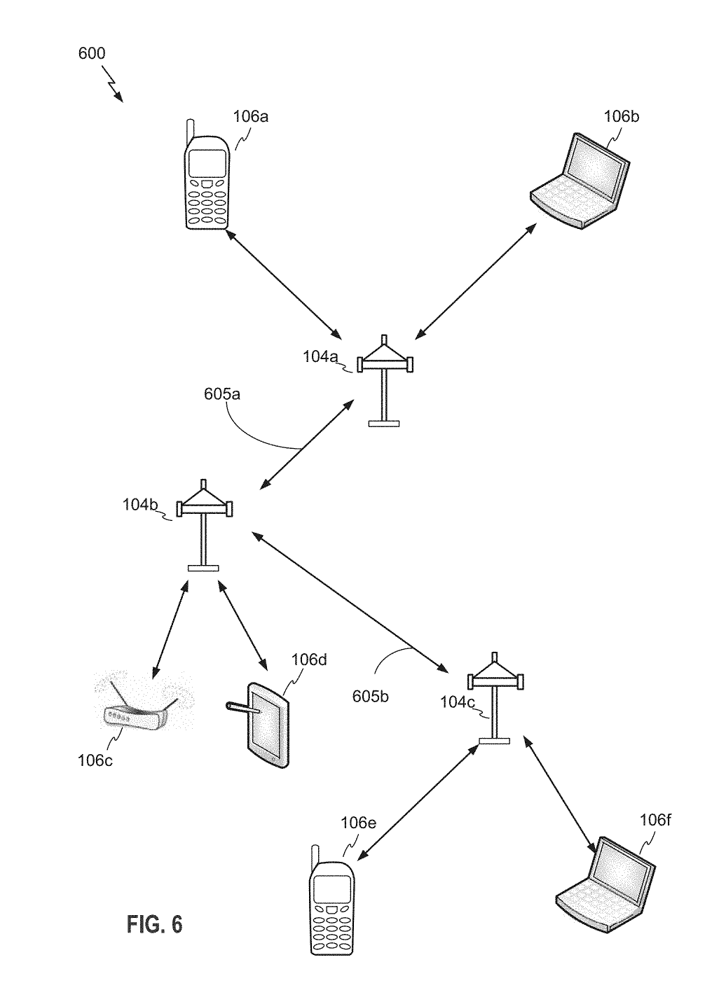

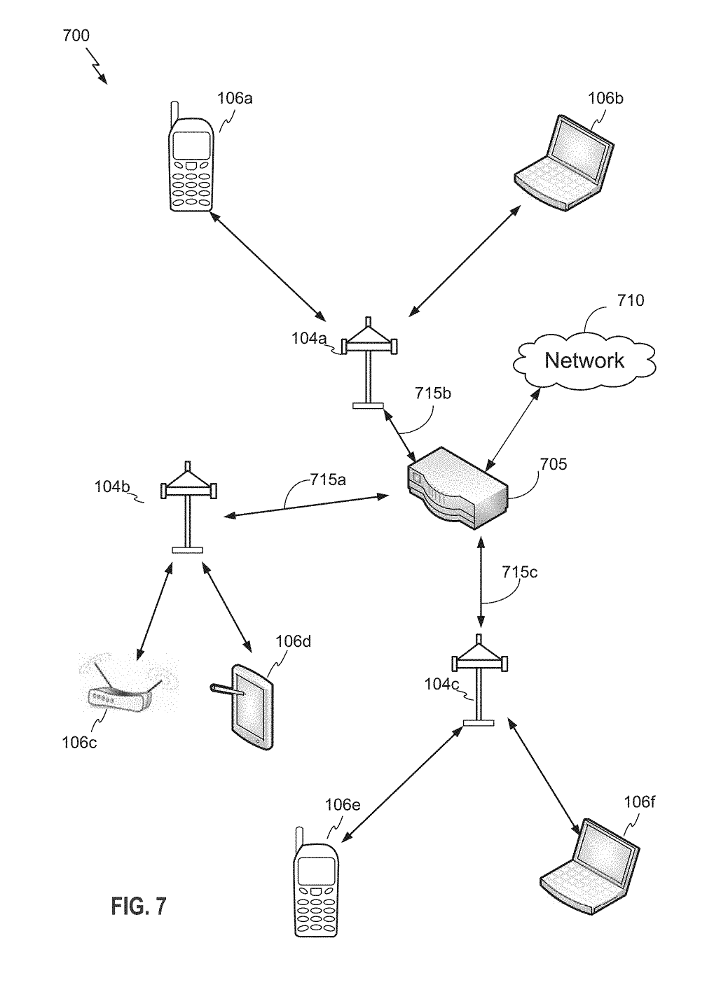

Each of FIGS. 6 and 7 schematically illustrates a corresponding example of a distributed MIMO communication system, identified as systems 600 and 700 respectively. The systems described with respect to each of FIGS. 6 and 7 may operate, in some aspects, in accordance with certain embodiments described herein. The exemplary distributed MIMO communication systems 600 and 700 can be configured to utilize distributed multiuser transmissions of uplink data (e.g., distributed uplink transmissions; distributed uplink multiuser communications) from stations of the wireless network. The exemplary distributed MIMO communication systems 600 and 700 includes a plurality of access points (e.g., three access points 104a-c) and a plurality of stations (e.g., six STAs 106a-f). While each of FIGS. 6 and 7 schematically illustrates three access points of the distributed MIMO communication system 600, 700, in other aspects, the distributed MIMO communication system 600, 700 may include fewer (such as two (2)) access points, or more than the three access points shown in FIGS. 6 and 7. In addition, while each of FIGS. 6 and 7 illustrates six stations included in the distributed MIMO communication systems 600 and 700, in other aspects, the distributed MIMO communication systems 600 and/or 700 may include fewer stations or more stations than the six shown in FIGS. 6 and 7.

Each access point 104a-c of FIGS. 6 and 7 is illustrated as being associated with and in communication with one or more stations, but is not associated with other stations. AP 104a is associated with STAs 106a-b, but is not associated with STAs 106c-d or STAs 106e-f. AP 104b is associated with STAs 106c-d, but is not associated with STAs 106a-b or STAs 106e-f. AP 104c is associated with STAs 106e-f, but is not associated with STAs 106a-b or STAs 106c-d. As described herein, an AP that is associated with a particular station means that the station and the AP have established a relationship whereby the station receives communication services from the access point. This may include the station transmitting an association request to the AP, requesting communication services from the AP. The AP, when the association is successful, may transmit an association response to the station. The AP may also provide an association identifier in the association response, that may be used by the station when requesting communication services from the AP.

Each access point and its associated stations may be referred to herein as a basic service set (BSS). Stations or access points that are not associated with the access point within a BSS may be referred to herein as being outside the BSS or OBSS devices. Thus, for example, STA 106b is within the same BSS as STA 106a and AP 104a, while STA 106c is an OBSS device with respect to STAs 106a-b and AP 104a. However, STA 106c is a BSS device with respect to STA 106d and AP 104b. While each of FIGS. 6 and 7 illustrates the distributed MIMO communication system 600, 700 having two stations associated with each access point (e.g., each BSS comprising two stations and an access point) and four stations not associated with each access point (e.g., each BSS having four stations which are OBSS devices), in other aspects, the distributed MIMO communication system 600, 700 may include fewer or more than two stations associated with each access point (e.g., in the BSS of an access point), may include fewer or more than four stations not associated with each access point (e.g., OBSS devices), may include different numbers of stations associated with each of the access points (e.g., in the BSS of an access point), and may include different numbers of stations not associated with each of the access points (e.g., OBSS devices).

In some aspects, an access point of the wireless network (e.g., an access point of a BSS) can receive a multiuser transmission from two or more stations of the wireless network (e.g., a first station and a second station). At least one of the stations (e.g., the second station) can be a station that is not associated with the access point (e.g., outside the BSS of the access point; an OBSS device). The access point can process the multiuser transmission to obtain uplink data from at least one of the stations with which it is not associated (e.g., an OBSS device; the first station). In some aspects, the processing of the multiuser transmission can comprise decoding the multiuser transmission to obtain the uplink data from the at least one of the other stations (e.g., an OBSS device; the first station).

Before a distributed MIMO communication is performed, two or more of the plurality of access points (e.g., the three access points 104a-c) may exchange information 605a-b, 715a c relating to the distributed MIMO communication. In some aspects, the information includes how much STA data is queued by one or more of the stations. In some aspects, the information includes information regarding channel conditions between APs of the distributed communication system (e.g. APs 104a-c) and STAs within the distributed communication system (e.g. STAs 106a-f). For example, AP 104a may determine and transmit sounding information relating to channel conditions for its BSS stations. In some aspects, AP 104a may also transmit sounding information relating to one or more OBSS stations. The channel conditions may include one or more of path loss information, received signal strength indications (RSSI), or other data indicating channel conditions of a communication path between the respective STAs and APs.

In some aspects, the information 605a-b, 715a-c can include user data (e.g., pre-coded or non-pre-coded) that may be transmitted as part of the distributed MIMO communication. For example, AP 104a may exchange information relating to user data that a BSS STA may uplink as part of a distributed uplink communication to AP 104b.

In some aspects, the information 605a-b, 715a-c can include information relating to channel conditions for communication paths between an access point (e.g., AP 104a) and stations within its BSS (e.g. STA 106a-b). For example, AP 104a may transmit information relating to channel conditions for communication paths to each of STAs 106a b, AP 104b may transmit information relating to channel conditions for communication paths to each of STAs 106c-d, and AP 104c may transmit information relating to channel conditions for communication paths to each of STAs 106e-f. One or more access points that receive this channel condition information may utilize this information during the distributed MIMO communication.

In some aspects, the information 605a-b, 715a-c can include information indicative of uplink data from at least one station that is not associated with the access point receiving the information. For example, AP 104a may receive information indicative of uplink data from one or more of STAs 106c-f (e.g., transmitted from at least one of AP 104b and 104c), AP 104b may receive information indicative of uplink data from one or more of STAs 106a-b and STAs 106e-f (e.g., transmitted from at least one of AP 104a and AP 104c), and AP 104c may receive information indicative of uplink data from one or more of STAs 106a-d (e.g., transmitted from at least one of AP 104a and AP 104b).

In some aspects, the information 605a-b, 715a-c can be communicated via network messages that are communicated directly among the access points, or communicated indirectly among the access points (e.g., via an access point acting as a cluster controller or via a cluster controller separate from the access points, as described more fully below with respect to FIG. 7). In certain of the aspects described in connection with FIGS. 6 and 7, one of the illustrated APs (e.g., 104a, 104b, 104c, etc.) may be a cluster controller. In one example, the AP 104a may be a cluster controller. In another example, the AP 104b may be a cluster controller. In an example where the AP 104a is a cluster controller, the AP 104b may negotiate with a second access point (e.g., the AP 104a) to determine that the AP 104a is a cluster controller. In another example where the AP 104a is a cluster controller, a device (e.g., the AP 104b) may receive configuration data indicating network parameters for a cluster controller (the AP 104a in this example), wherein the network parameters are associated with cluster controller capabilities for the AP 104a.

In some aspects, a network message (e.g., from an access point) can indicate that one or more BSS stations of the access point have uplink data for transmission. For example, an access point (e.g., AP 104a) can receive a first network message indicating that an associated station (e.g., stations in the BSS of the access point; STAs 106a-b) has uplink data for transmission. The access point can also receive a second network message indicating that a non-associated station (e.g., OBSS stations; STAs 106c-f) has uplink data for transmission (e.g. from an access point in a different BSS; the access point in the same BSS as are the OBSS stations). In certain such aspects, the access point can determine a first uplink channel for the associated station (e.g., the BSS station) and a second uplink channel for the non-associated station (e.g., the OBSS station) based on the first and second network messages, and can transmit a third network message indicating the second uplink channel for the non-associated station (e.g., the OBSS station). In some aspects, this third network message may be transmitted to the non-associated station's BSS AP (e.g., the access point in the same BSS as the OBSS station). In some other aspects, the third network message may be transmitted to a cluster controller. In some aspects, a device controlling a distributed uplink communication (such as an access point or a cluster controller) may determine a time for the distributed multiuser transmission based on the first and second network messages, and can transmit another network message indicating the determined time. If the device determining the time is, for example, a first access point, a message indicating the time may be transmitted both to the first access point's BSS station participating in the distributed uplink MIMO communication, and another message to another second AP, which may be the BSS AP of a second station participating in the distributed uplink MIMO communication that is not associated with the first AP (e.g., an OBSS AP). In some aspects, a single message may be transmitted. The message may be addressed to both the BSS AP and an OBSS AP of the first AP. For example, the message may include a cluster identifier for a cluster that includes the group of APs performing the distributed uplink MIMO transmission. In some aspects, the message may be broadcast or multicast such that both the BSS AP and OBSS AP receive the message.

In some aspects, a network message (e.g., from a cluster controller) can indicate that one or more stations are transmitting at least a portion of the multiuser transmission. For example, an access point (e.g., AP 104a) can receive from a cluster controller a first network message indicating that an associated station (e.g., a BSS station; STAs 106a-b) and a non-associated station (e.g., an OBSS station; STAs 106c-f) are transmitting at least a portion of the multiuser transmission. In certain such aspects, the access point can further receive, from the cluster controller, a second network message indicating a time of the multiuser transmission. In some aspects, the access point can further receive, from the cluster controller, a third network message indicating a channel for the first station to transmit the multiuser transmission. In certain such aspects, the access point can determine that the associated station has uplink data for transmission to the access point and can transmit, to the cluster controller, a fourth network message indicating that the associated station has the uplink data.

One or more access points that receive this information 605a-b, 715a-c may utilize this information 605a-b, 715a-c to process the multiuser transmission during the distributed MIMO communication. For example, processing the multiuser transmission can comprise nulling uplink data from at least one station that is not associated with the access point (e.g., at least one OBSS station). Upon receiving the information indicative of the uplink data from the at least one non-associated station (e.g., the at least one OBSS station), the access point can use the information to generate nulling data for the uplink data, and can null the uplink data from the at least one non-associated station (e.g., the at least one OBSS station) based on the nulling data. For example, upon receiving the information 605a, 715b indicative of uplink data from one or more of STAs 106b-f (which are not associated with AP 104a and thus are OBSS stations to AP 104a), AP 104a can use the information to generate nulling data for the uplink data, and can null the uplink data from one or more of STAs 106b-f based on the nulling data during the distributed MIMO communication.

In some aspects, such nulling (e.g., interference nulling) can advantageously be used by the access points to process at least some of the simultaneous data transmissions of the stations while discarding others. In certain such aspects, such nulling can advantageously assist with processing (e.g., decoding) the simultaneous data transmissions from the stations, wherein not all the stations are associated with the same access point. For example, an access point (e.g., AP 104a) may discard the data transmissions from OBSS stations (e.g., STAs 106c-f). Such nulling can be facilitated by the information exchanged among the access points (e.g., through the cluster controller 705 or directly with one another).

In some aspects, coding mechanisms (e.g., pre-coding) may be used to increase robustness of the data transmissions of the stations. For example, in some aspects, devices transmitting the wireless communications described herein (e.g., distributed MIMO communications) may utilize various data and coding techniques to improve the security and/or the robustness for the communications. For example, a downlink distributed MIMO communication may be transmitted from the AP 104a to the station 106a simultaneously with a transmission from the AP 104d to the station 106a. The source data included in one or more of the communications may be encoded, for example, into a plurality of symbols. As one having ordinary skill in the art will appreciate, a data and coding scheme may utilize, for example, fountain codes, raptor codes, etc. The receiving device (e.g., the station 106a) may recover the encoded data by decoding the plurality of symbols or a subset of the plurality of symbols and then formatting the decoded data into a plurality of data units. In some aspects, the transmitting devices and the receiving device may comprise any of the other wireless devices described herein. For example, the receiving device in this example may be the AP 104a, while the transmitting devices in this example may be neighboring APs (e.g., AP 104b and AP 104c). Other examples are described herein in connection with FIGS. 6 and 7.

In some aspects, the information 605a-b, 715a-c may be transmitted over a back-haul network, such as a wired network. The back-haul network may have a greater capacity than the wireless network, and therefore the increased total amount of data being exchanged between the access points, does not reduce the available capacity of the wireless medium shared by the access points (e.g., APs 104a-c).

In some aspects, as schematically illustrated by FIG. 6, one of the access points (e.g., AP 104b) may be considered as a cluster controller (e.g., an uplink distributed MIMO controller) that facilitates the uplink distributed MIMO communication, and the access point considered to be the cluster controller may obtain information from each of the other access points within the distributed MIMO communication system 600, 700. For example, AP 104a may transmit information regarding STAs 106a-b to APs 104b as part of the distributed MIMO communication, AP 104b may transmit information regarding STAs 106c-d to AP 104a and to AP 104c as part of the distributed MIMO communication, AP 104c may transmit information regarding STAs 106e-f to AP 104b as part of the distributed MIMO communication, AP 104b may transmit the information received from AP 104a regarding STAs 106a-b to AP 104c as part of the distributed MIMO communication, and AP 104b may transmit the information received from AP 104c regarding STAs 106e-f to AP 104a as part of the distributed MIMO communication. The access point considered to be the cluster controller can be determined via negotiations among the access points. In some aspects, one or more access points can receive configuration data indicating network parameters for the cluster controller, wherein the network parameters are associated with cluster controller capabilities.

In some aspects, referring to the distributed MIMO communication system 600 schematically illustrated by FIG. 6, AP 104b can query the other access points (e.g., AP 104a, AP 104c) for information 605a-b regarding the stations (e.g., STAs 106c-f) that are not associated with AP 104a (e.g., that are OBSS stations to AP 104a). AP 104b and AP 104c can transmit the information 605a b to AP 104a in a periodic manner (e.g., at predetermined intervals of time) or in an event-based manner (e.g., at the occurrence of predetermined events). AP 104b can determine the set of stations and access points of the distributed MIMO communication system 600 to be used in a multiuser transmission. In some aspects, AP 104b advantageously facilitates determining the set of stations of the distributed MIMO communication system 600 that will be transmitting simultaneously (e.g., the set of stations participating in the multiuser transmission). In some aspects, AP 104b advantageously facilitates determining the set of access points of the distributed MIMO communication system 600 that will be processing (e.g., decoding) the multiuser transmissions of the stations (e.g., the receiving access points).

In certain aspects, as schematically illustrated by FIG. 7, the distributed MIMO communication system 700 can include a cluster controller 705 (e.g., an uplink distributed MIMO controller) that is separate from the access points. In some aspects, as schematically illustrated by FIG. 7, data destined for any STA within the distributed MIMO communication system 700, such as any of the STAs 106a-f, may first be received at the cluster controller 705 from a network 710. In some aspects, each of the access points can be in operative communication with the cluster controller 705 such that the cluster controller 705 may obtain information 715a-c from each of the access points within the distributed MIMO communication system 700 (e.g. APs 104a-c).

In some aspects, referring to the distributed MIMO communication system 700 schematically illustrated by FIG. 7, the cluster controller 705 can query the access points (e.g., APs 104a-c) for information 715a-c regarding the stations (e.g., STAs 106a-f). For another example, the access points can transmit the information 715a-c regarding the stations to the cluster controller 705 in a periodic manner (e.g., at predetermined intervals of time) or in an event-based manner (e.g., at the occurrence of predetermined events). The cluster controller 705 can determine the set of stations and access points of the distributed MIMO communication system 700 to be used in a multiuser transmission. In some aspects, the cluster controller 705 advantageously facilitates determining the set of stations of the distributed MIMO communication system 700 that will be transmitting simultaneously (e.g., the set of stations participating in the multiuser transmission). In some aspects, the cluster controller 705 advantageously facilitates determining the set of access points of the distributed MIMO communication system 700 that will be processing (e.g., decoding) the multiuser transmissions of the stations (e.g., the receiving access points).

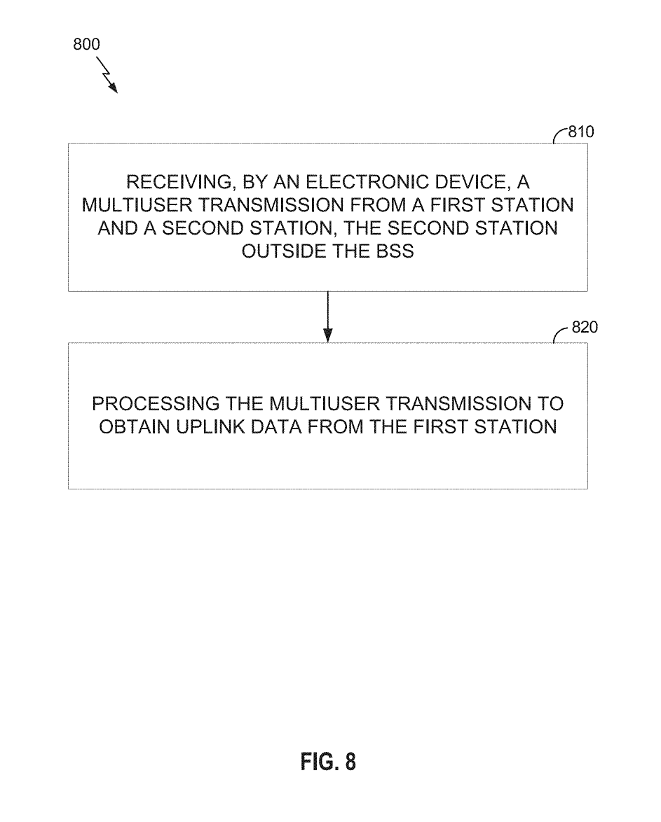

FIG. 8 is a flow diagram of an example method 800 for receiving an uplink transmission in accordance with certain embodiments described herein. In some aspects, the method 800 discussed below with respect to FIG. 8 may be performed by the wireless device 202. For example, in some aspects, the memory 206 may store instructions that configure the processor 204 to perform one or more of the functions described below with respect to FIG. 8. In some aspects, the method 800 discussed below with respect to FIG. 8 may be performed by any of the access points discussed above with respect to FIGS. 6-7, and in various aspects, may incorporate one or more of the functions discussed above with respect to the access points of FIGS. 6-7.

In some aspects, the example method 800 for receiving an uplink transmission advantageously facilitates determining the set of stations that will be transmitting simultaneously (e.g., the stations participating in an uplink distributed MIMO communication) and advantageously facilitates determining the set of access points that will be receiving and processing (e.g., decoding) the data transmissions from the participating stations. Furthermore, in some aspects, the example method 800 advantageously facilitates processing (e.g., decoding) the simultaneous data transmissions from the stations, wherein not all the stations are associated with the same access point. In some aspects, the example method 800 provides these advantages by having an access point receive a multiuser transmission from a station that is not associated with the access point and having the access point process the multiuser transmission to discard the transmission from the station that is not associated with the access point.

In block 810, the method 800 comprises receiving, by an electronic device, a multiuser transmission from a first station and a second station of a wireless network. The first station is in a basic service set (BSS) and the second station is outside the BSS (e.g., an OBSS to the access point). For example, the electronic device can comprise a cluster controller, or an access point in the BSS (e.g., the access point in the BSS can be a cluster controller), and the first station can be associated with the access point (e.g., a BSS station to the access point) and the access point can determine sounding information (e.g., for at least the first station; for the first station and the second station). The first station can also transmit the sounding information to a second device, such as a second access point or a cluster controller.

In some aspects, the cluster controller can be an access point. For example, the cluster controller can be determined to be a second access point (e.g., via negotiations of the first access point with the second access point). For determining the cluster controller, the access point can receive configuration data indicating network parameters associated with cluster controller capabilities.

In some aspects, the access point can receive a first network message (e.g., from a cluster controller) that indicates that the first station has uplink data for transmission, and can also receive a second network message (e.g., from the cluster controller) that indicates that the second station has uplink data for transmission. The first and second network messages can indicate that the first and second stations are transmitting at least a portion of the multiuser transmission. Based on the first and second network messages, the access point can determine at least one of: a first uplink channel for the first station (e.g., based on an instruction from a cluster controller), a second uplink channel for the second station, and a time for the multiuser transmission. The access point can transmit a third network message that indicates at least one of: the first uplink channel for the first station, the second uplink channel for the second station, and the determined time for the multiuser transmission. For example, the network messages received by the access point (e.g., from the cluster controller) can indicate at least one of: a time of the multiuser transmission and a channel for the first station to transmit the multiuser transmission. In some aspects, the access point can transmit (e.g., in response to the third network message; to the cluster controller) a network message that indicates that the first station has the uplink data based on the determining that the first station has uplink data for transmission. In some aspects, the third network message can be transmitted to the second station, and the second station can be responsive to the third network message by transmitting uplink data based on the indicated second uplink channel. In some aspects, a fourth network message can be received from the cluster controller, the fourth network message indicating a channel for the second station to transmit the multiuser transmission.

In block 820, the multiuser transmission is processed to obtain uplink data from the first station. The processing of the multiuser transmission can comprise nulling uplink data from the second station. For example, the access point can receive information indicative of the uplink data from the second station, can generate nulling data for the uplink data (e.g., channel information for nulling the uplink data) and can perform the nulling based on the nulling data (e.g., based on the channel information). This information can be received by the access point via a backhaul network. In some aspects, the access point may then transmit the obtained uplink data over the network 710, for example, based on a destination address for the uplink data provided either in the uplink data itself or in a control header associated with the distributed uplink MIMO transmission.

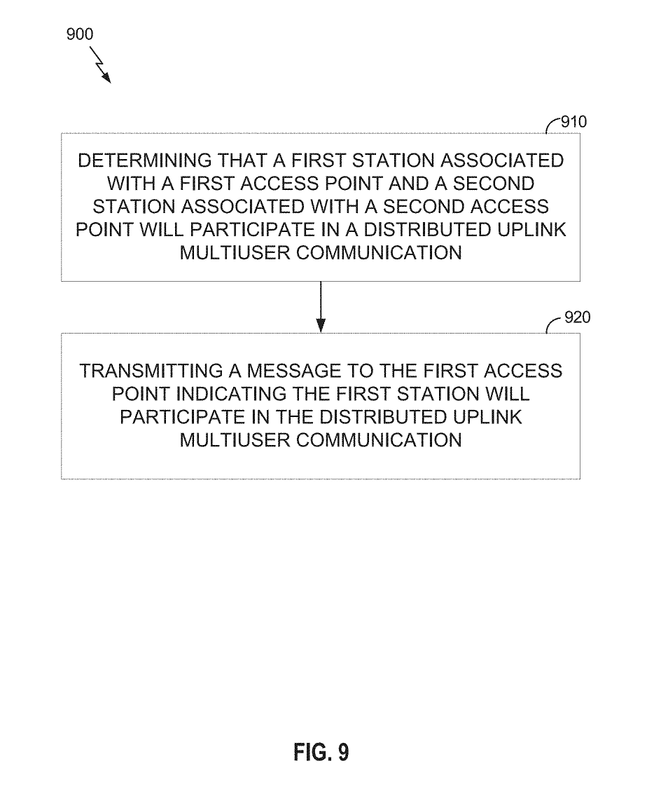

FIG. 9 is a flow diagram of an example method 900 for coordinating a distributed uplink transmission in accordance with certain embodiments described herein. In some aspects, the method 900 discussed below with respect to FIG. 9 may be performed by the wireless device 202. For example, in some aspects, the memory 206 may store instructions that configure the processor 204 to perform one or more of the functions described below with respect to FIG. 9. In some aspects, the method 900 discussed below with respect to FIG. 9 may be performed by any of the access points discussed above with respect to FIGS. 6-7, and in various aspects, may incorporate one or more of the functions discussed above with respect to the access points of FIGS. 6-7. In some other aspects, the method 900 may be performed by the cluster controller 705, discussed above with respect to FIG. 7.

In some aspects, the example method 900 for coordinating a distributed uplink transmission advantageously facilitates determining a set of stations that will be transmitting simultaneously (e.g., the stations participating in an uplink distributed MIMO communication) and advantageously facilitates determining a set of access points that will be receiving and processing (e.g., decoding) the data transmissions from the participating stations. Furthermore, in some aspects, the example method 900 advantageously facilitates processing (e.g., decoding) the simultaneous data transmissions from the stations, when not all the stations are associated with the same access point. In some aspects, the example method 900 provides these advantages by having a cluster controller determine that a station associated with one access point and another station associated with another access point will participate in the distributed uplink MIMO communication and having the cluster controller transmit a message to the access point indicating that the associated station will participate in the distributed uplink MIMO communication. Processing by the access point can then include discarding the data transmissions from the station that is not associated with the access point (e.g., by interference nulling). In some other aspects, an access point that is part of a cluster provides the controller functions.

In block 910, the method 900 comprises determining, by an electronic device (e.g., a cluster controller), that a first station associated with a first access point (e.g., a BSS station of the first access point) and a second station associated with a second access point (e.g., a BSS station of the second access point) will participate in a distributed uplink multiuser communication. In some aspects, the message further indicates the second station will participate in the distributed uplink multiuser communication. In some aspects, the electronic device also determines a time for the distributed uplink multiuser communication and/or a first channel for the first station to transmit data for the distributed uplink multiuser communication. In some aspects, the electronic device can also determine a second channel for the second station to transmit data for the distributed uplink multiuser communication. The electronic device can transmit a network message to the first access point indicating at least one of the time, the first channel, and the second channel. Similarly, the electronic device can transmit a network message to the second access point indicating at least one of the time, the first channel, and the second channel.

In some aspects in which the electronic device is a cluster controller, the cluster controller can receive information indicative of the uplink data from the first station, and can transmit (e.g., via a network message) the information indicative of the uplink data to the second access point. The cluster controller can also transmit to the second access point (e.g., via one or more network messages) the time for the distributed uplink multiuser communication and/or an indication that the second station will participate in the distributed uplink multiuser communication. In some aspects, the cluster controller receives sounding information for the first station from the first access point and transmits data derived from the sounding information for the first station to the second access point. For example, the cluster controller can decode the sounding information to determine one or more of a path-loss, and a received signal strength indication (RSSI) of first station, and can determine the data based on the path-loss or RSSI of the first station

In block 920, the method 900 comprises transmitting, by the electronic device, a message to the first access point indicating the first station will participate in the distributed uplink multiuser communication. In some aspects, the electronic device can receive a message from the first access point indicating the first station has data for transmission, and can transmit the message indicating the first station will participate in the distributed uplink multiuser communication to the electronic device in response to the message from the first access point indicating that first station has data for transmission. In some aspects, a third message is received from the second access point indicating the second station has data for transmission.

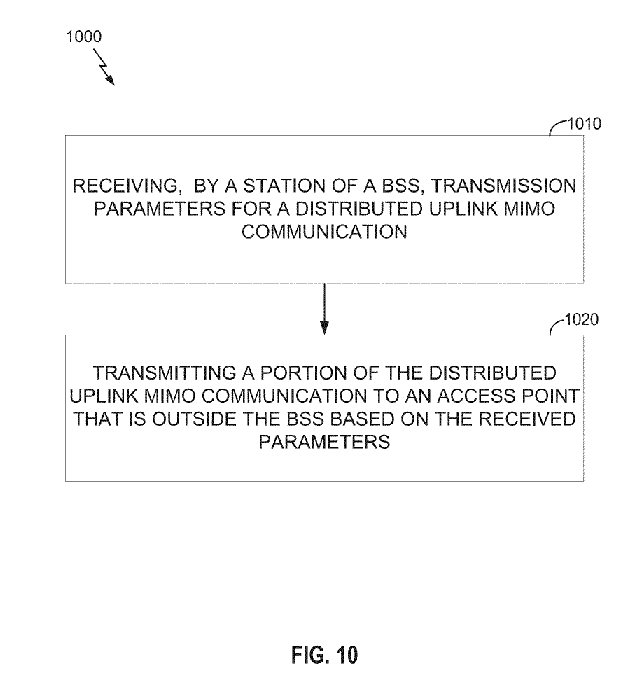

FIG. 10 is a flow diagram of an example method 1000 for performing a portion of a distributed uplink MIMO communication in accordance with certain embodiments described herein. In some aspects, the method 1000 discussed below with respect to FIG. 10 may be performed by the wireless device 202. For example, in some aspects, the memory 206 may store instructions that configure the processor 204 to perform one or more of the functions described below with respect to FIG. 10. In some aspects, method 1000 may be performed by any of the stations described above with respect to FIGS. 6-7.

In some aspects, the example method 1000 for performing a portion of a distributed uplink MIMO communication advantageously facilitates determining the set of stations that will be transmitting simultaneously (e.g., the stations participating in an uplink distributed MIMO communication) and advantageously facilitates determining the set of access points that will be receiving and processing (e.g., decoding) the data transmissions from the participating stations. Furthermore, in some aspects, the example method 1000 advantageously facilitates processing (e.g., decoding) the simultaneous data transmissions from the stations, wherein not all the stations are associated with the same access point. In some aspects, the example method 1000 provides these advantages by having a station receive transmission parameters from an access point (e.g., that is associated with the station) and transmitting a portion of the distributed uplink MIMO communication to a second access point that is not associated with the station.

In a block 1010, the method 1000 comprises receiving, by a station of a BSS, transmission parameters for a distributed uplink MIMO communication. For example, the received transmission parameters can include at least one of: a destination address for the distributed uplink MIMO communication, spatial channels, and frequency channels.

In a block 1020, the method further comprises transmitting, by the station, a portion of the distributed uplink MIMO communication to an access point that is outside the BSS based on the received transmission parameters. In some aspects, the method 100 further comprises receiving sounding information for the access point, wherein the portion of the distributed uplink MIMO communication is transmitted based on the sounding information. The transmission parameters can be received by the station from the access point or from an access point different from the access point (e.g., an access point that is associated with the station).

Further disclosed herein is a method of coordinating a distributed uplink transmission, comprising: determining, by an electronic device, that a first station associated with a first access point and a second station associated with a second access point will participate in a distributed uplink multiuser communication; and transmitting, by the electronic device, a message to the first access point indicating the first station will participate in the distributed uplink multiuser communication. The message to the first access point further indicates the second station will participate in the distributed uplink multiuser communication. The method further comprises: determining, by the electronic device, a time for the distributed uplink multiuser communication; and transmitting, by the electronic device, a network message to the first access point indicating the time. In an aspect, the message to the first access point further comprises a first channel for the first station to transmit data for the distributed uplink multiuser communication. In an aspect, the message to the first access point further comprises a second channel for the second station to transmit data for the distributed uplink multiuser communication. The method further comprises: receiving a second message from the first access point indicating the first station has data for transmission; and transmitting the message in response to the second message. The method further comprises receiving a third message from the second access point indicating the second station has data for transmission. In an aspect, the electronic device is a cluster controller. The method further comprises: receiving, by the electronic device, information indicative of the uplink data from the first station; transmitting, by the electronic device, the information indicative of the uplink data to the second access point. The method further comprises: transmitting, by the electronic device, a network message to the second access point indicating a time for the distributed uplink multiuser communication. The method further comprises transmitting a second message to the second access point indicating the second station will participate in the distributed uplink multiuser communication. The method further comprises: receiving sounding information for the first station from the first access point; and transmitting data derived from the sounding information for the first station to the second access point. The method further comprises: decoding the sounding information to determine one or more of a path-loss, and a received signal strength indication (RSSI) of the first station; and determining the data based on the path-loss or RSSI of the first station.

Further disclosed herein is an apparatus for wireless communication, comprising: an electronic hardware processor configured to coordinate a distributed uplink transmission, wherein the electronic hardware processor is configured to: determine, by an electronic device, that a first station associated with a first access point and a second station associated with a second access point will participate in a distributed uplink multiuser communication; and transmit, by the electronic device, a message to the first access point indicating the first station will participate in the distributed uplink multiuser communication. In an aspect, the message to the first access point further indicates the second station will participate in the distributed uplink multiuser communication. In an aspect, the electronic hardware processor is further configured to: determine, by the electronic device, a time for the distributed uplink multiuser communication; and transmit, by the electronic device, a network message to the first access point indicating the time. In an aspect, the message to the first access point further comprises a first channel for the first station to transmit data for the distributed uplink multiuser communication. In an aspect, the message to the first access point further comprises a second channel for the second station to transmit data for the distributed uplink multiuser communication. In an aspect, the electronic hardware processor is further configured to: receive a second message from the first access point indicating the first station has data for transmission; and transmit the message in response to the second message. In an aspect, the electronic hardware processor is further configured to receive a third message from the second access point indicating the second station has data for transmission. In an aspect, the electronic device is a cluster controller. In an aspect, the electronic hardware processor is further configured to: receive, by the electronic device, information indicative of the uplink data from the first station; transmit, by the electronic device, the information indicative of the uplink data to the second access point. In an aspect, the electronic hardware processor is further configured to: transmit, by the electronic device, a network message to the second access point indicating a time for the distributed uplink multiuser communication. In an aspect, the electronic hardware processor is further configured to transmit a second message to the second access point indicating the second station will participate in the distributed uplink multiuser communication. In an aspect, the electronic hardware processor is further configured to: receive sounding information for the first station from the first access point; and transmit data derived from the sounding information for the first station to the second access point. In an aspect, the electronic hardware processor is further configured to: decode the sounding information to determine one or more of a path-loss, and a received signal strength indication (RSSI) of the first station; and determine the data based on the path-loss or RSSI of the first station.

Further disclosed herein is a non-transitory computer-readable medium comprising instructions that, when executed, perform a method of receiving an uplink transmission, the method comprising: receiving, by an electronic device, a multiuser transmission from a first station and a second station of a wireless network, wherein the first station is in a basic service set (BSS) and the second station is outside the BSS; and processing the multiuser transmission to obtain uplink data from the first station. In an aspect, the electronic device comprises a cluster controller. In an aspect, the electronic device comprises an access point in the BSS. In an aspect, processing the multiuser transmission comprises nulling uplink data from the second station. In an aspect, the method further comprises: receiving, by the access point, information indicative of the uplink data from the second station; generating channel information for the uplink data; and wherein said nulling is based on the channel information. In an aspect, the method further comprises receiving the information indicative of the uplink data via a backhaul network. In an aspect, the method further comprises: determining sounding information for the first station; transmitting, by the access point, the sounding information to a second device. In an aspect, the second device is a second access point. In an aspect, the second device is a cluster controller. In an aspect, the second device is a cluster controller. In an aspect, the method further comprises associating with the first station. In an aspect, the method further comprises receiving a first network message indicating the first station has uplink data for transmission. In an aspect, the method further comprises receiving a second network message indicating the second station has uplink data for transmission. In an aspect, the method further comprises: determining a first uplink channel for the first station and a second uplink channel for the second station based on the first and second network messages; and transmitting a third network message indicating the first uplink channel for the first station. In an aspect, the third network message further indicates the second uplink channel for the second station. In an aspect, said determining the first uplink channel is based on an instruction from a cluster controller. In an aspect, the method further comprises transmitting the third network message to the first station, the first station responsive to the third network message by transmitting uplink data based on the indicated first uplink channel. In an aspect, the method further comprises transmitting the third network message to the second station, the second station responsive to the third network message by transmitting uplink data based on the indicated second uplink channel. In an aspect, the method further comprises: determining a time for the multiuser transmission based on the first and second network messages; and transmitting a third network message indicating the determined time. In an aspect, the method further comprises: receiving, from a cluster controller, a first network message indicating the first station and the second station are transmitting at least a portion of the multiuser transmission. In an aspect, the method further comprises receiving, from the cluster controller, a second network message indicating a time of the multiuser transmission. In an aspect, the method further comprises receiving, from the cluster controller, a third network message indicating a channel for the first station to transmit the multiuser transmission. In an aspect, the method further comprises receiving, from the cluster controller, a fourth network message indicating a channel for the second station to transmit the multiuser transmission. In an aspect, the method further comprises: determining, by the access point, that the first station has uplink data for transmission to the access point; and transmitting, to the cluster controller, a fourth network message indicating the first station has the uplink data based on said determining that the first station has uplink data for transmission. In an aspect, the method further comprises negotiating with a second access point to determine the second access point is a cluster controller. In an aspect, the method further comprises receiving configuration data indicating network parameters for a cluster controller, the network parameters associated with cluster controller capabilities.

Further disclosed herein is a non-transitory computer-readable medium comprising instructions that, when executed, perform a method of coordinating a distributed uplink transmission, the method comprising: determining, by an electronic device, that a first station associated with a first access point and a second station associated with a second access point will participate in a distributed uplink multiuser communication; and transmitting, by the electronic device, a message to the first access point indicating the first station will participate in the distributed uplink multiuser communication. In an aspect, the message to the first access point further indicates the second station will participate in the distributed uplink multiuser communication. In an aspect, the method further comprises: determining, by the electronic device, a time for the distributed uplink multiuser communication; and transmitting, by the electronic device, a network message to the first access point indicating the time. In an aspect, the message to the first access point further comprises a first channel for the first station to transmit data for the distributed uplink multiuser communication. In an aspect, the message to the first access point further comprises a second channel for the second station to transmit data for the distributed uplink multiuser communication. In an aspect, the method further comprises: receiving a second message from the first access point indicating the first station has data for transmission; and transmitting the message in response to the second message. In an aspect, the method further comprises receiving a third message from the second access point indicating the second station has data for transmission. In an aspect, the electronic device is a cluster controller. In an aspect, the method further comprises: receiving, by the electronic device, information indicative of the uplink data from the first station; transmitting, by the electronic device, the information indicative of the uplink data to the second access point. In an aspect, the method further comprises: transmitting, by the electronic device, a network message to the second access point indicating a time for the distributed uplink multiuser communication. In an aspect, the method further comprises transmitting a second message to the second access point indicating the second station will participate in the distributed uplink multiuser communication. In an aspect, the method further comprises: receiving sounding information for the first station from the first access point; and transmitting data derived from the sounding information for the first station to the second access point. In an aspect, the method further comprises: decoding the sounding information to determine one or more of a path-loss, and a received signal strength indication (RSSI) of the first station; and determining the data based on the path-loss or RSSI of the first station.

Further disclosed herein is a non-transitory computer-readable medium comprising instructions that, when executed, perform a method of performing a portion of a distributed uplink MIMO communication, the method comprising: receiving, by a station, associated with a first access point having a basic service set (BSS), transmission parameters for a distributed uplink MIMO communication; and transmitting, by the station, a portion of the distributed uplink MIMO communication to a second access point that is outside the BSS based on the received transmission parameters. In an aspect, the received transmission parameters include at least one of: a destination address for the distributed uplink MIMO communication, spatial channels, and frequency channels. In an aspect, the method further comprises receiving sounding information for the second access point, wherein the portion of the distributed uplink MIMO communication is transmitted based on the sounding information. In an aspect, the transmission parameters are received by the station from the first access point. In an aspect, the transmission parameters are received by the station from the second access point. In an aspect, the method further comprises associating with the first access point.

Further disclosed herein is a method of performing a portion of a distributed uplink multiple-input and multiple-output (MIMO) communication, the method comprising: transmitting a first communication, to a first wireless device, from a second wireless device that is inside a first basic service set (BSS); in response to transmitting the first communication, receiving, from a first access point that is inside the first BSS, by the second wireless device, a set of transmission parameters for the distributed uplink MIMO communication; and based on the received transmission parameters, transmitting, to a second access point that is outside the first BSS, from the second wireless device, at least one communication that is part of the distributed uplink MIMO communication. In an aspect, the received transmission parameters include at least one of: a destination address for the distributed uplink MIMO communication, spatial channels, and frequency channels. In an aspect, the method further comprises receiving sounding information for the second access point, wherein the portion of the distributed uplink MIMO communication is transmitted based on the sounding information. In an aspect, the transmission parameters are received by the second wireless device from the first access point. In an aspect, the transmission parameters are received by the second wireless device from the second access point. In an aspect, the method further comprises associating with the first access point.

Further disclosed herein is an apparatus for performing a portion of a distributed uplink multiple-input and multiple-output (MIMO) communication, the apparatus comprising an electronic hardware processor configured to cause the apparatus to: transmit a first communication to a first wireless device that is inside a first basic service set (BSS); in response to transmitting the first communication, receive, from a first access point that is inside the first BSS, a set of transmission parameters for the distributed uplink MIMO communication; and based on the received transmission parameters, transmit, to a second access point that is outside the first BSS, at least one communication that is part of the distributed uplink MIMO communication. In an aspect, the received transmission parameters include at least one of: a destination address for the distributed uplink MIMO communication, spatial channels, and frequency channels. In an aspect, the electronic hardware processor is further configured to receive sounding information for the second access point, wherein the portion of the distributed uplink MIMO communication is transmitted based on the sounding information. In an aspect, the transmission parameters are received by the apparatus from the first access point. In an aspect, the transmission parameters are received by the apparatus from the second access point. In an aspect, the electronic hardware processor is further configured to associate with the first access point.

### Terminology

In the above description, reference numbers may have been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor or any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. In some aspects, the means for receiving may comprise one or more of the receiver 212, the transceiver 214, the DSP 220, the processor 204, the memory 206, the signal detector 218, the cellular modem 234, the WLAN modem 238, or equivalents thereof. In some aspects, means for transmitting may comprise one or more of the transmitter 210, the transceiver 214, the DSP 220, the processor 204, the memory 206, the cellular modem 234, the WLAN model 238, or equivalents thereof. In some aspects, the means for determining, means for utilizing, means for excluding, means for signaling, means for initiating, means for initiating, means for measuring, means for separately determining, means for adjusting, means for deriving, means for combining, or means for evaluating may comprise one or more of the DSP 220, the processor 204, the memory 206, the user interface 222, the cellular modem 234, the WLAN modem 238, or equivalents thereof.

Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of performing a portion of a distributed uplink multiple-input and multiple-output (MIMO) communication, the method comprising:
receiving, by a first wireless device, a first communication from a second wireless device that is inside a first basic service set (BSS);
receiving, by the first wireless device, a second communication from a third wireless device that is outside the first BSS;
processing, by the first wireless device, one or both of the first and second communications;
based on the processing, determining, by the first wireless device, first uplink data from the second wireless device; and
in response to determining the first uplink data, transmitting, by the first wireless device, at least one communication that is part of the distributed uplink MIMO communication.

2. The method of claim 1, wherein either the first wireless device or the second wireless device is a cluster controller, wherein one or both of the first and second wireless devices is an access point, and wherein the first wireless device communicates with the second wireless device.

3. The method of claim 1, further comprising:
based on the processing, determining, by the first wireless device, second uplink data from the third wireless device,
wherein processing one or both of the first and second communications comprises one or more of:
decoding the first uplink data,
nulling the second uplink data, and
forwarding the second uplink data to an access point associated with the third wireless device.

4. The method of claim 1, further comprising:
receiving, by the first wireless device, from the third wireless device, via a backhaul network, information indicative of second uplink data from the third wireless device;
generating channel information for the second uplink data based on the received information; and
nulling the second uplink data based on the generated channel information.

5. The method of claim 1, further comprising:
determining, by the first wireless device, sounding information for the second wireless device; and
transmitting, by the first wireless device, the sounding information to a fourth wireless device.

6. The method of claim 1, wherein the second wireless device and the third wireless device are included in an upload transmission group based on one or more of:
a first buffer level of the second wireless device,
a second buffer level of the third wireless device,
a first set of upload channel conditions for the first wireless device, and
a second set of upload channel conditions for an access point associated with the third wireless device.

7. The method of claim 1, further comprising:
based on the processing, determining, by the first wireless device, second uplink data from the third wireless device;
receiving, by the first wireless device, a first network message indicating that the second wireless device has the first uplink data; and
receiving, by the first wireless device, a second network message indicating that the third wireless device has the second uplink data.

8. The method of claim 7, further comprising:
determining, by the first wireless device, a first uplink channel based on the first network message; and
transmitting, by the first wireless device, to the second wireless device, a third network message indicating that the second wireless device is to transmit the first uplink data over the first uplink channel.

9. The method of claim 7, further comprising:
determining, by the first wireless device, a second uplink channel based on the second network message; and
transmitting, by the first wireless device, to the third wireless device, a third network message indicating that the third wireless device is to transmit the second uplink data over the second uplink channel.

10. The method of claim 7, further comprising:
determining, by the first wireless device, a time for a multiuser transmission based on the first and second network messages; and
transmitting, by the first wireless device, a third network message indicating the determined time.

11. The method of claim 1, further comprising receiving, by the first wireless device, a first network message indicating that the second and third wireless devices are transmitting at least a portion of a multiuser transmission.

12. The method of claim 11, further comprising receiving, by the first wireless device, a second network message indicating a time for the multiuser transmission.

13. The method of claim 12, further comprising at least one of:
receiving, by the first wireless device, a third network message indicating a channel for the second wireless device to transmit the multiuser transmission; and
receiving, by the first wireless device, a fourth network message indicating a channel for the third wireless device to transmit the multiuser transmission.

14. The method of claim 11, further comprising:
determining, by the first wireless device, that the second wireless device has the first uplink data; and
in response to the determining, transmitting, by the first wireless device, a second network message that indicates that the second wireless device has the first uplink data.

15. A method of performing a portion of a distributed uplink multiple-input and multiple-output (MIMO) communication, the method comprising:
transmitting a first communication, to a first wireless device, from a second wireless device that is inside a first basic service set (BSS);
in response to transmitting the first communication, receiving, from a first access point that is inside the first BSS, by the second wireless device, a set of transmission parameters for the distributed uplink MIMO communication; and
based on the received transmission parameters, transmitting, to a second access point that is outside the first BSS, from the second wireless device, at least one communication that is part of the distributed uplink MIMO communication.

16. An apparatus for performing a portion of a distributed uplink multiple-input and multiple-output (MIMO) communication, the apparatus comprising an electronic hardware processor configured to cause the apparatus to:
receive a first communication from a second wireless device that is inside a first basic service set (BSS);
receive a second communication from a third wireless device that is outside the first BSS;
process one or both of the first and second communications;
based on the processing, determine first uplink data from the second wireless device; and
in response to determining the first uplink data, transmit at least one communication that is part of the distributed uplink MIMO communication.

17. The apparatus of claim 16, wherein either the apparatus or the second wireless device is a cluster controller, wherein one or both of the apparatus and the second wireless device is an access point, and wherein the apparatus communicates with the second wireless device.

18. The apparatus of claim 16, wherein the electronic hardware processor is further configured to cause the apparatus to:
based on the processing, determine second uplink data from the third wireless device,
wherein processing one or both of the first and second communications comprises one or more of:
decoding the first uplink data,
nulling the second uplink data, and
forwarding the second uplink data to an access point associated with the third wireless device.

19. The apparatus of claim 16, wherein the electronic hardware processor is further configured to cause the apparatus to:
receive from the third wireless device, via a backhaul network, information indicative of second uplink data from the third wireless device;
generate channel information for the second uplink data based on the received information; and
null the second uplink data based on the generated channel information.

20. The apparatus of claim 16, wherein the electronic hardware processor is further configured to cause the apparatus to:
determine sounding information for the second wireless device; and
transmit the sounding information to a fourth wireless device.

21. The apparatus of claim 16, wherein the second wireless device and the third wireless device are included in an upload transmission group based on one or more of:
a first buffer level of the second wireless device,
a second buffer level of the third wireless device,
a first set of upload channel conditions for the apparatus, and
a second set of upload channel conditions for an access point associated with the third wireless device.

22. The apparatus of claim 16, wherein the electronic hardware processor is further configured to cause the apparatus to:
based on the processing, determine second uplink data from the third wireless device;
receive a first network message indicating that the second wireless device has the first uplink data; and
receive a second network message indicating that the third wireless device has the second uplink data.

23. The apparatus of claim 22, wherein the electronic hardware processor is further configured to cause the apparatus to:
determine a first uplink channel based on the first network message; and
transmit to the second wireless device, a third network message indicating that the second wireless device is to transmit the first uplink data over the first uplink channel.

24. The apparatus of claim 22, wherein the electronic hardware processor is further configured to cause the apparatus to:
determine a second uplink channel based on the second network message; and
transmit to the third wireless device, a third network message indicating that the third wireless device is to transmit the second uplink data over the second uplink channel.

25. The apparatus of claim 22, wherein the electronic hardware processor is further configured to cause the apparatus to:
determine a time for a multiuser transmission based on the first and second network messages; and
transmit a third network message indicating the determined time.

26. The apparatus of claim 16, wherein the electronic hardware processor is further configured to cause the apparatus to receive a first network message indicating that the second and third wireless devices are transmitting at least a portion of a multiuser transmission.

27. The apparatus of claim 26, wherein the electronic hardware processor is further configured to cause the apparatus to receive a second network message indicating a time for the multiuser transmission.

28. The apparatus of claim 27, wherein the electronic hardware processor is further configured to cause the apparatus to at least one of:
receive a third network message indicating a channel for the second wireless device to transmit the multiuser transmission; and
receive a fourth network message indicating a channel for the third wireless device to transmit the multiuser transmission.

29. The apparatus of claim 26, wherein the electronic hardware processor is further configured to cause the apparatus to:
determine that the second wireless device has the first uplink data; and
in response to the determining, transmit a second network message that indicates that the second wireless device has the first uplink data.

30. An apparatus for performing a portion of a distributed uplink multiple-input and multiple-output (MIMO) communication, the apparatus comprising an electronic hardware processor configured to cause the apparatus to:
transmit a first communication to a first wireless device that is inside a first basic service set (BSS);
in response to transmitting the first communication, receive, from a first access point that is inside the first BSS, a set of transmission parameters for the distributed uplink MIMO communication; and
based on the received transmission parameters, transmit, to a second access point that is outside the first BSS, at least one communication that is part of the distributed uplink MIMO communication.
